(19) United States
(12) Patent Application Publication
(10) Pub. No.: US 2017/0341673 A1
(43) Pub. Date: Nov. 30, 2017

(54) CHASSIS WITH HIGH MOVEMENT SUSPENSION

(71) Applicant: NOBEBOP LIMITED, Oxford (GB)

(72) Inventor: Stewart MORLEY, Dorset (GB)

(21) Appl. No.: 15/534,694

(22) PCT Filed: Dec. 3, 2015
(86) PCT No.: PCT/GB2015/053695

§ 371 Date: Jun. 9, 2017

(30) Foreign Application Priority Data
Dec. 9, 2014 (GB) 1421836.6

(51) Int. Cl. B62B 9/18; B62B 7/04

(52) U.S. Cl. CPC B62B 9/18; B62B 7/04; B62B 2301/20; B62B 2301/04

(57) ABSTRACT

The present invention provides a wheeled conveyance (10) having a chassis (12) having a first base member (12a) and having a longitudinal axis X, a plurality of wheels (14, 16, 18, 20) and a suspension system (22) between one or more of the plurality of wheels (14, 16, 18, 20) and the chassis (12), wherein said suspension system (22) has on or more front arms (24a, 24b) extending in a generally forward (F) and outward direction (O) and being mounted to the chassis (12) for substantially vertical movement about a pivot axis A-A or B-B which extends at an acute angle of a relative to longitudinal axis X. The arrangement is more able to absorb shock and more stable than arrangements of the prior art.

The present invention relates to a chassis with a high movement suspension system and relates particularly to such a chassis and suspension system as may be used on, for example, a child's pushchair or the like.

It is well known to provide pushchairs and the like with suspension systems such as to help with the smooth passage of the pushchair over uneven terrain and obstacles such as curbstones and steps. One example of a pushchair with long suspension arms is shown in GB 2470094 which, whilst providing a potential solution to the above-mentioned problem transmits a significant torque reaction through the suspension in a manner that causes it to be experienced by the occupant of the pushchair. In addition, when pushchairs need tilting in urban environments (such as for a high curb) pressure on the pushchair arm must first take up the rear suspension before the front wheels lift from the ground. This softness is unattractive to many users.

It is an object of the present invention to provide a chassis and suspension system which reduces and possibly eliminates the above-mentioned problems by providing an arrangement in which the front suspension arms can rotate independently about hinges on the chassis; while the rear wheel arm can rotate about the sub-chassis center-line such as to enable the rear wheels to move up and down. This provides a smooth ride from each suspension arm and reduced shock to the child from random bumps. In addition, when the chassis is tipped back the front wheels lift immediately without any compression of the suspension.

Accordingly, the present invention provides: a wheeled conveyance having a chassis having a first base member and having a longitudinal axis X, a plurality of wheels and a suspension system between one or more of the plurality of wheels and the chassis wherein said suspension system has one or more front arms extending in a generally forward F and outward direction θ and being mounted to the chassis for substantially vertical movement about a pivot axis A-A or B-B which extends at an acute angle of a relative to longitudinal axis X.

Preferably, angle α is between 75 and 89 degrees.

Preferably, angle α is between 79 and 85 degrees.

Preferably, angle α is between 80 and 84 degrees.

Preferably, angle α is 82 degrees.

Advantageously, said angle α is such that a perpendicular L2A, L2B to axis A-A or B-B crosses said longitudinal axis X at a point C generally rearward of axis A-A or B-B.

In a particular arrangement said conveyance includes a rear axis Y-Y about which a pair of rear wheels 18, 20 rotate and wherein angle α is such that a perpendicular L2A, L2B to axis A-A or B-B crosses said longitudinal axis X at a point C coincident with axis Y-Y.

Advantageously, the arrangement further includes a rear suspension member having a left side and a right side and being mounted to said chassis for pivotal movement about the central axis X.

Preferably, said rear suspension member comprises a substantially rigid cross-member having a first end on the left side and a second end on said right side and including a longitudinal axis Y and wherein said axis Y is substantially perpendicular to the axis X of the chassis and further wherein a wheel is provided at each end and each wheel is mounted for rotation about said axis Y or about an axis substantially parallel thereto.

Advantageously, the arrangement includes a damping mechanism to damp any motion between the one or more front arms and the chassis.

Conveniently, said damping mechanism comprises a compressible member mounted on the chassis.

The arrangement may further include a compressible member above each of the front arms.

Preferably, the one or more front arms may be each mounted on one or more hinge plates which are each mounted on said chassis for pivotal movement about one or other of axes A-A or B-B.

Advantageously, said one or more hinge plates includes a lower surface and wherein said damper mechanism extends between said lower surface and said first base member of the chassis.

Advantageously, said rear suspension member includes one or more second damping members to damp any movement of the rear suspension member about axis X.

Advantageously, said chassis may further include a plurality of mountings for receiving a mounted body.

Advantageously, the chassis may include a top plate mounted above said first member and wherein said one or more damper members are mounted therebetween.

Preferably, one or more of said one or more mountings are mounted on said top plate.

Preferably, said front wheels comprise castor wheels.

The present invention will now be more particularly described by way of example only with reference to the accompanying drawings, in which:

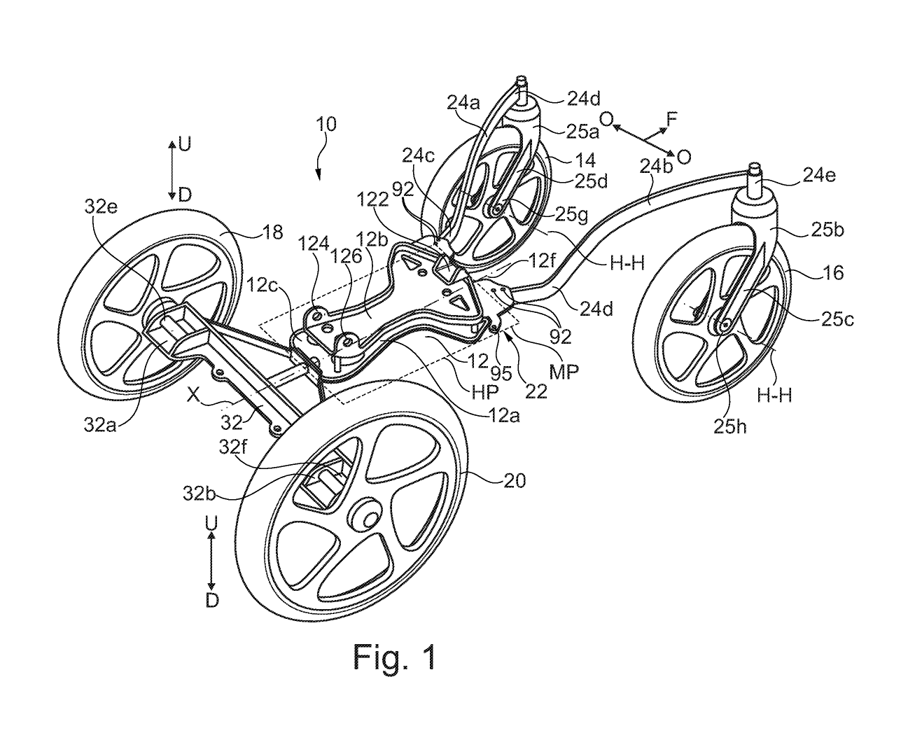

FIG. 1 is a general view of the chassis and suspension system with the chassis cover removed;

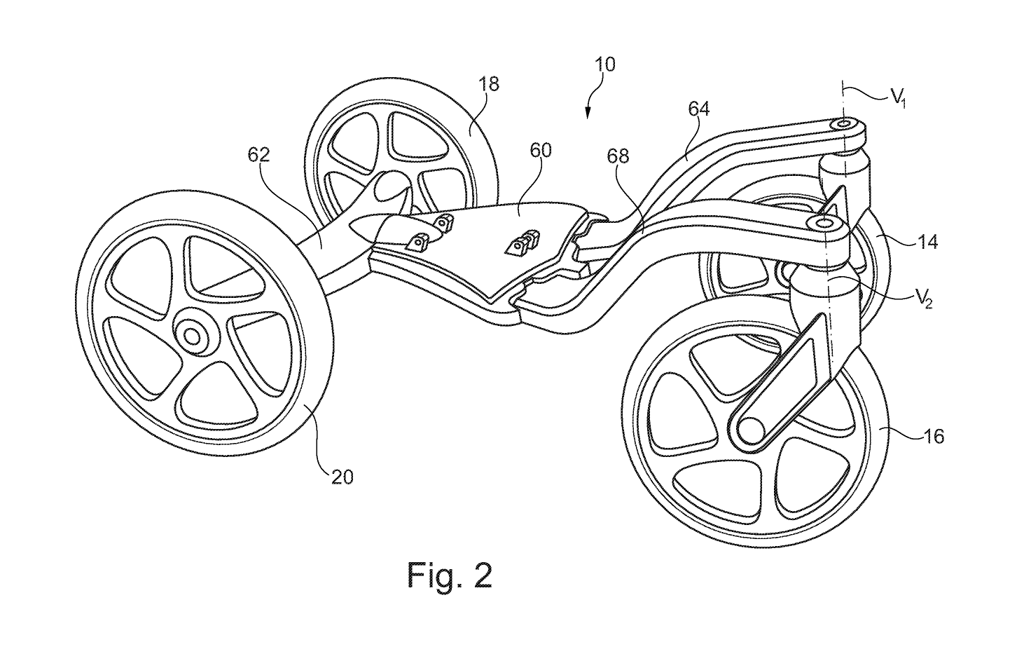

FIG. 2 is a further general view of the chassis and suspension system but with the chassis covers in position and clearly showing the mounting points for mounting an upper portion;

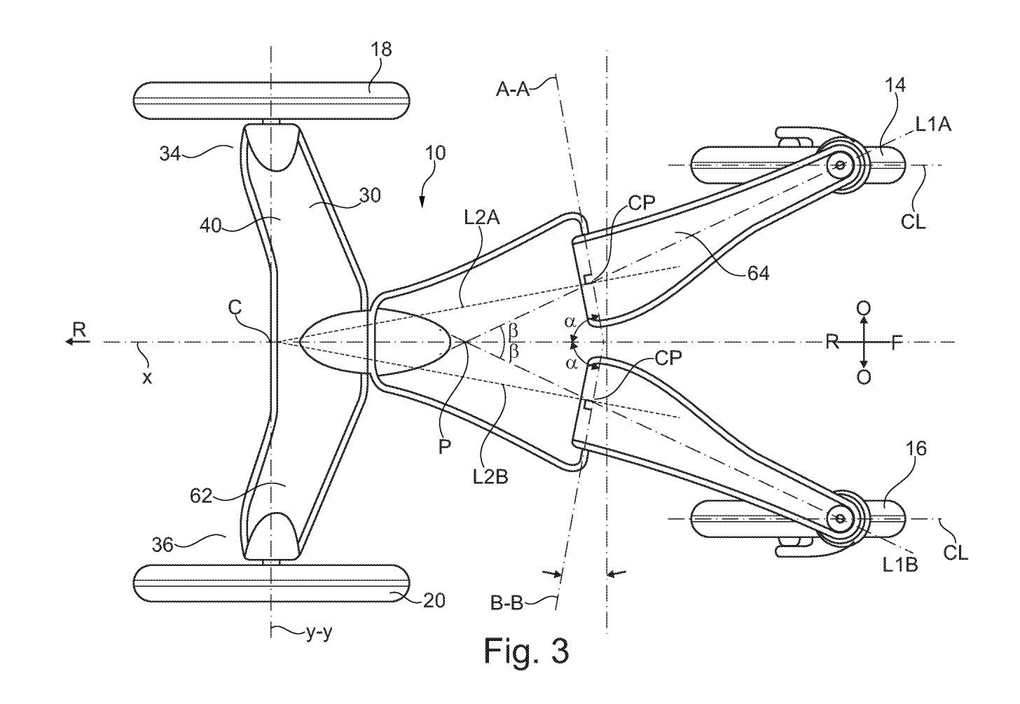

FIG. 3 is a plan view of the chassis and suspension system on FIGS. 1 and 2 and illustrates the angular relationship between members of the suspension and the chassis;

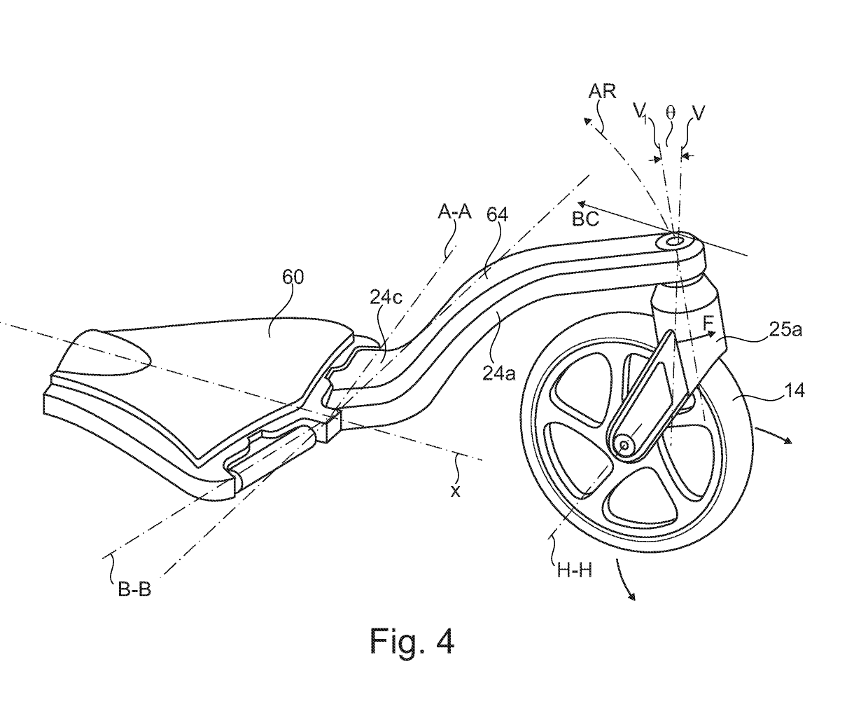

FIG. 4 is a general isometric view of one of the two front suspension members together with the castor wheel mounted thereon and which illustrates the freedom of motion of the wheel and the suspension arm;

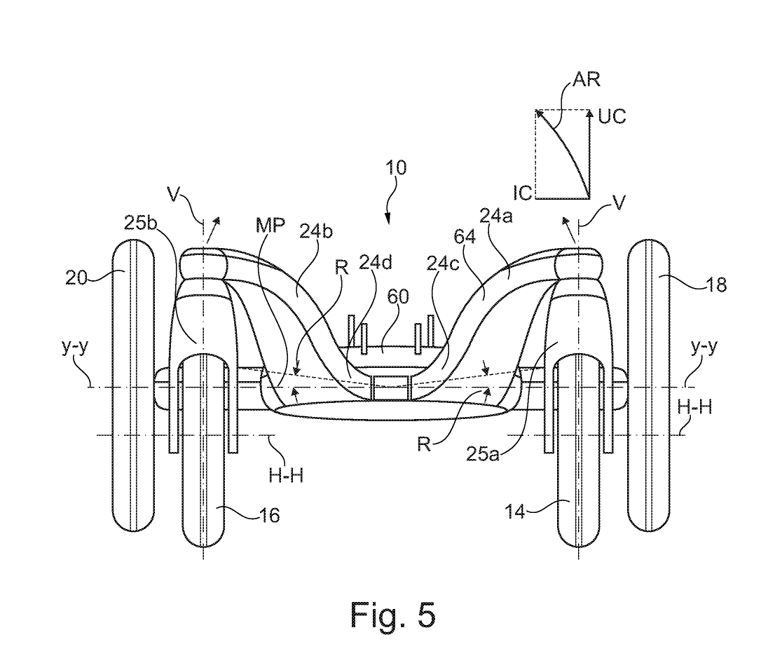

FIG. 5 is a front view of the front suspension and illustrates the movement of the front wheels during vertical displacement.

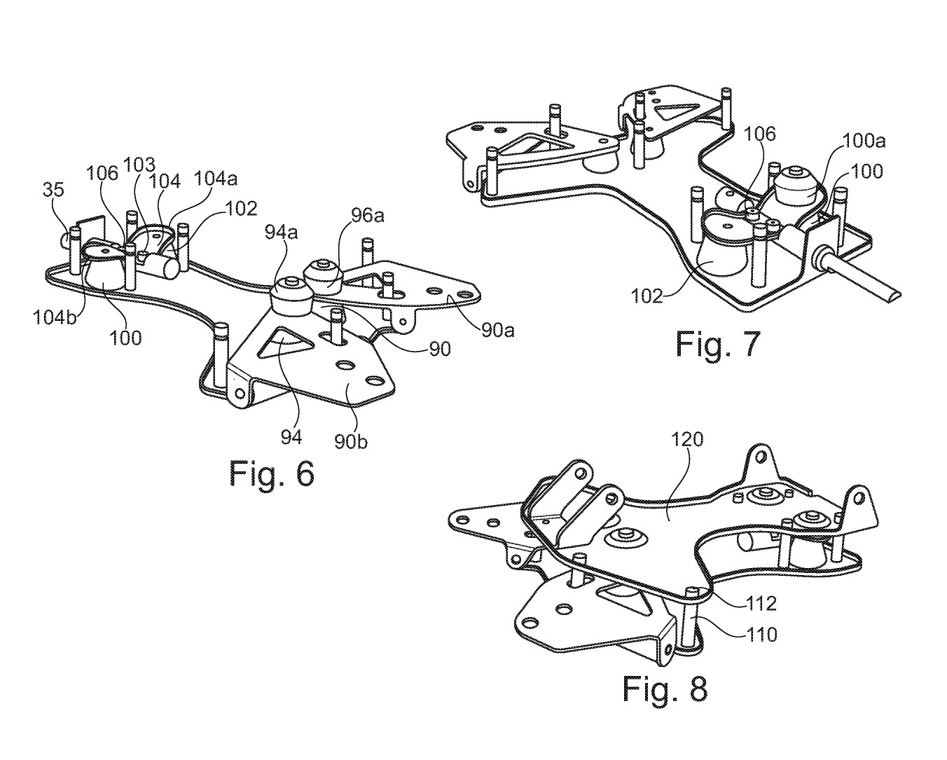

FIGS. 6 to 8 are detailed views of the chassis and elements of the suspension mounted thereon;

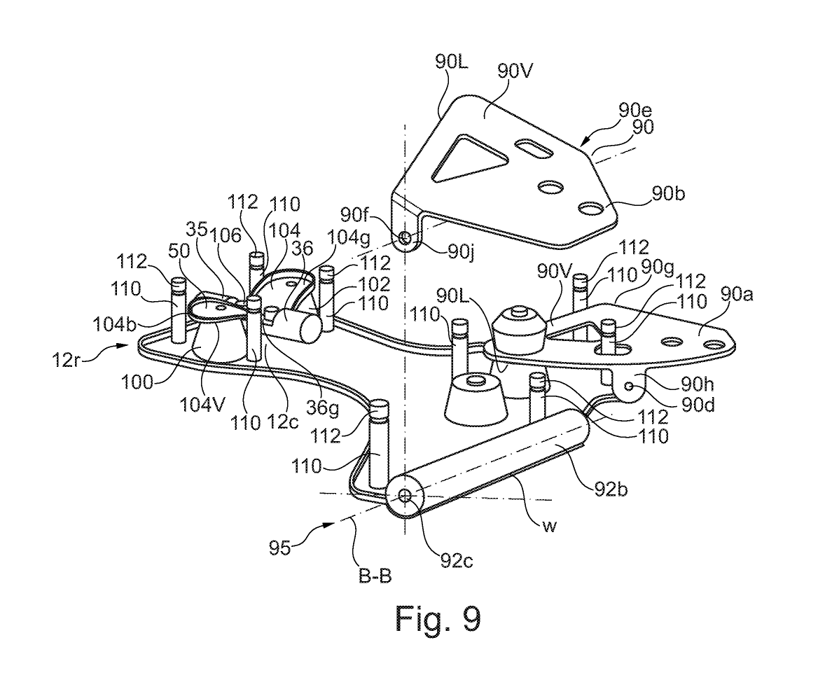

FIG. 9 is a detailed exploded view of a portion of the front suspension clearly showing the angular relationship between it and the chassis itself; and

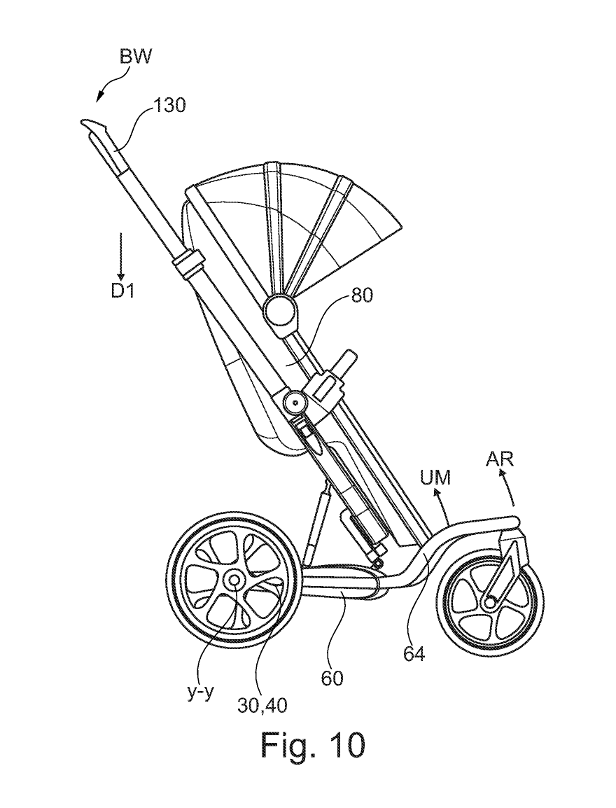

FIG. 10 is a side view of the chassis and suspension system and including an upper portion upon which may be mounted a child seat or the like.

Referring now to the drawings in general but particularly to FIGS. 1, 2 and 3 a wheeled conveyance 10 includes a chassis 12 having a first base member 12a extending in a generally horizontal plane HP and a longitudinal axis X around which are positioned a plurality of wheels 14, 16, 18, 20 and upon which is mounted a suspension system referenced generally at 22. The suspension system 22 includes one or more front arms 24a, 24b extending in a generally forward direction F and outwardly O from a front portion 12f of the chassis 12 and each includes at distal ends thereof 24d, 24e a caster wheel arrangement 14, 16 discussed in more detail later herein. The arms 24a, 24b are each mounted for substantially vertical pivotal movement V about an axis A-A or B-B, best seen in FIG. 3, each of which extend at an acute angle α relative to longitudinal axis X and, in one arrangement, preferentially also extend in or parallel to horizontal plane HP. An alternative arrangement would include the axes A-A and B-B extending at an angle R relative to the main plane MP of the chassis itself (FIGS. 1 and 5) such as to raise the outside end of the hinge which will help the wheel more easily roll over an obstacle. Whilst it will be appreciated that the angle α may be varied, it has been found that an angle of between 75 and 89 degrees and preferably between 79 and 85 degrees and still more preferably between 80 and 84 degrees is desirable. In the much preferred arrangement and as drawn, the angle is 82 degrees. The arms 24a, 24b may also be cranked or curved outwardly O such as to position the wheels further apart and allow easier access therebetween. The angling of the front arms is such that a perpendicular P to angle α crosses the longitudinal axis X at a point C generally rearwards of axis A-A or B-B but before or on the axis Y-Y of a rear suspension member 30, as discussed later herein with reference to FIG. 3. The rear suspension member 30 may comprise a rigid rear end having no movement relative to the chassis 12 but preferably comprises a semi-rigid rear end shown generally at 40 and arranged such as to allow individual vertical displacement of one or other of wheels 18, 20 attached thereto relative to the chassis 12 whilst limiting or preventing collective vertical displacement of the wheels 18, 20 relative to the chassis.

The rear suspension member 30 may comprise a substantially rigid cross-member 32 having a left side 32a and a right side 32b and being mounted to said chassis 12 for pivotal movement about the central axis X. in more detail, the cross-member 32 has a first end 32e on the left side 32a and a second end 32f on said right side 32b and including a longitudinal axis Y and wherein said axis Y is substantially perpendicular to the axis X of the chassis 12. A wheel 18 or 20 is provided at each end and each is mounted for rotation about said axis Y or about an axis substantially parallel thereto.

Reference is now made briefly to FIGS. 6 and 9 which illustrate the mounting of cross-member 32 in more detail and from which it will be appreciated that the cross-member 32 is provided with a centrally located pivot axle 34 which extends along axis X of the chassis 12 and which is shaped and positioned such as to be a rotating fit within a suitably shaped housing 36 mounted at a rearward end 12r of the chassis 12. The housing itself 36 may comprise two portions and include an open portion 36s for receiving a rotation damping/limiting device identified generally at 50 and discussed in more detail later herein or may be closed and include an alternative arrangement of rotation limiting device 50.

From the above, it will be appreciated that the rear cross-member 32 is able to pivot about axis X and allow one or other of the wheels 18, 20 to move upwardly U or downwardly D whilst restricting the other to move in the opposite manner. This provides a good degree of suspension travel to absorb shock from bumps and unevenness in a surface but, as the arrangement is restricted to rotate about axis X and any rotation is restricted within housing 36 the arrangement prevents collective vertical movement of the two wheels together and, thus, in effect, provides a collective rigidity to the rear cross-member 32. This is important to the effective operation of one aspect of the present invention as will be discussed in detail later herein.

Referring now once again to FIG. 2, the chassis 12 and rear cross-member 32 may be covered with protective casings identified at 60 and 62 and secured to their respective portions by any suitable conventional means, such as screwing or bonding. The front arms 24a, 24b may also be covered by protective casings 64, 68 secured in similar manner.

FIG. 3 illustrates the angular relationship between the chassis 12 and the various members of the suspension and from which it can be appreciated that the front arms 24a, 24b are each mounted for substantially vertical pivotal movement V about an axis A-A or B-B, each of which extend at an acute angle α relative to longitudinal axis X. The arms 24a, 24b are each also cranked or curved outwardly O such that the centre-line CL of operation is laterally outwards of a central point CP of the pivot axis A-A or B-B. Each of the castor wheel arrangements 14, 16 is mounted to rotate about an inclined but substantially vertical axis V₁, or V₂ as shown in more detail with reference to FIG. 4. The angle of the arms 24a, 24b measured from the centre line X to the vertical axis V₁, or V₂ of the wheels and through the centre point CP of the pivot axis A-A or B-B is represented by angle β and a line connecting the substantially vertical axes V₁, or V₂ and the centre line X by passing through associated central point CP is represented by line L_{1A} or L_{1B}. It will be appreciated that lines L_{1A} and L_{1B} each cross the centre line X of the chassis 12 at a point P rearward of the pivot axes A-A and B-B but forward of the rear axis Y. This point P is the point to be associated with the mounting of a mounted body such as, for example, a child seat 80 discussed in more detail later herein with reference to FIG. 10. A second line L_{2A}, L_{2B} taken as a perpendicular to respective axes A-A or B-B crosses the centre line X at or near the position C at which axis Y crosses axis X. This triangulation and the effect it has on the effective operation of the overall apparatus is also discussed later herein with reference to FIGS. 4 and 5.

Turning now more particularly to FIGS. 4 and 5, it will be appreciated that the front caster wheels 14, 16 are each mounted on a support arm 25a, 25b having a substantially rearwardly extending portion 25c, 25d and front portions 25e, 25f. The front portions 25e, 25f are mounted to each rotate around respective substantially vertical axis V₁ or v₂. Each axis V₁, V₂ is angled from a true vertical V by an amount known as the castor angle θ. Whilst the degree of castor may be varied, it has been found that an angle of between 5 and 2 degrees and preferably 2 to 3 degrees is preferred. The wheels themselves 14, 16 are mounted in a conventional manner at rear portions 25g, 25h of portions 25c, 25d for rotation about substantially horizontal axes H-H.

The associated arms 24a and 24b each pivot about pivot axes A-A or B-B. The motion of movement of each wheel 14, 16 is that of an arc referenced by arrow AR in each of FIGS. 4 and 5 and having a backward component BC an upward component UC and an inward component IC. The degree of backward movement of the arc AR can be appreciated from FIG. 4 whilst the degree of inward movement is best appreciated with reference to FIG. 5. This movement is all determined relative the central line X of the chassis and the rear axis Y and means that the wheels 14, 16 move in a substantially different manner to that known in the art. The motion of the wheels of FIGS. 4 and 5 is such as to allow the suspension system 22 to absorb or accommodate erratic movement of the front wheels whilst ensuring a high degree of stability of the chassis and anything mounted thereon whilst also channeling any forces created by the impact which causes the deflection inwardly towards axis X and to a point on the central line itself rather than parallel thereto as known in the prior art. It will be appreciated that the extent of travel of the wheels 14, 16 is equal to the length of the arc AR and that this is of greater length than the pure vertical or upward component UC of movement of the wheels. This means that the front suspension has a greater total length of travel for a given vertical displacement of the wheel over an obstacle than is possible in the prior art which has no inward component IC. The additional travel allows the suspension more time/distance of travel to accommodate the movement and, hence, the suspension is more able to accommodate shock loading than the prior art might. In addition, the fact that the front wheels are castor wheels means that the conveyance 10 can approach an obstacle at an angle and the wheel will turn to face the obstacle before climbing it and the suspension will still operate in a smooth manner and without excessive shock being transmitted through to the chassis 12. In the event that load is transferred to the chassis 12 it is done in a manner that channels any torque effect towards the centre line X rather than parallel thereto and, hence, less of a torque reaction will be created and experienced by any occupant.

FIGS. 6 to 9 show the internal arrangement of the chassis 12 in more detail and from which it can be appreciated that each of the front arms 24a, 24b may be mounted onto hinge plates 90a, 90b by means of bolts or the like (92 in FIG. 1) and that the hinge plates are mounted for pivotal movement about one or other of axis A-A or B-B. A cylindrical element or simple spacer 92a, 92b may be mounted to the chassis under each hinge plate 90a, 90b and acts to receive a bolt or pivot pin 95 (shown in more detail in FIG. 1) through a central bore 92c, 92d (not shown). The pivot pin 95 acts to secure the plate 90a, 90b to the chassis 12 by passing through the holes 90c, 90d, 90e, 90f at the ends 90g, 90h, 90i, 90j of the plates around which the respective plates rotate. Alternatively, a simple spindle arrangement may be used. Each front arm 24a, 24b is provided with a resilient energy absorbing member in the form of, for example, a silicon, rubber or metal spring shown generally at 94 which acts to react against any vertical movement of respective arms 24a, 24b in the manner well known in the art and, therefore, not described in detail further. Whilst it will be appreciated that the spring arrangement 94 may take any one of a number of forms, it has been found that an arrangement comprising a compression spring working against each of the upper and lower surfaces 90U and 90L of each plate 90a, 90b is very effective as this will allow for the spring to always act in compression when reacting against movement. Alternatives such as tension spring arrangements are also possible.

The rear end 12r of the chassis 12 provides a mounting for the housing 36 mentioned above which accommodates axle 35 such as to allow it to rotate therein and allow wheels 18, 20 to move as described above. The degree of movement may be limited and controlled by the addition of further spring members 100, 102 the same as those described above in relation to the front arms 24a, 24b. A cross-plate 104 is secured to the axle 34 by means of, for example, bolts 106 and crosses to either side of the axle 34 and extends outwardly to 104a and 104b at which one or more spring members 100, 102 are positioned in a manner which secures them between the chassis 12 and the under-surface 104U of cross-plate 104. Two further spring members 100a, (FIG. 7) 100b (not shown) may also be placed above plate 104 such as to further assist The springs act as compression springs to limit the degree of motion and control the rate of movement and, thereby, provide the rear wheels 18, 20 with such shock absorbency as may be required. Other forms of spring or damping arrangements such as torque tubes may also be suitable for such arrangements.

FIGS. 6 to 8 also illustrate a plurality of support posts 110 extending upwardly from chassis 12 and having upper ends 112 for receiving a top chassis portion 12b which may be provided with a plurality of mountings 122, 124, 126 for receiving a mounted body, such as for example, a baby seat 80. The positioning of the seat 80 is above point P, mentioned in relation to FIG. 3, and is shown in detail in FIG. 10. As this is the point about which the front suspension operates and to which energy is channeled, a passenger in the seat is positioned substantially above the central point P of suspension operation and will experience less lateral displacement or shock than might be experienced in an arrangement of the prior art. Also apparent from FIG. 10 is the position of the handle 130 associated with the arrangement. The handle 130 is positioned rearward of the seat 80 and rearward of the rear axis Y-Y such that vertically downward pressure on the handle by an operator will be reacted by the vertically stiff rear suspension 30, 40 which supports the rear wheels 18, 20. As a consequence of the vertical stiffness of the rear suspension, any force exerted downwardly in the direction of arrow D1 will be directly and immediately transferred to the suspension. Consequently, backward and downward movement of the handle 130 in the direction of arrow BW will directly and immediately cause the conveyance 10 to pivot about axis Y-Y and lift the front suspension arms 24d, 24e and wheels 14, 16. This is in stark contrast with the arrangements of the prior art which must first compress the suspension before any lifting of the front wheels is possible.

1. A wheeled conveyance having a chassis having a first base member and having a longitudinal axis X, a plurality of wheels and a suspension system between one or more of the plurality of wheels the chassis, wherein said suspension system has one or more front arms, extending in a generally forward F and outward direction O and being mounted to the chassis for substantially vertical movement about a pivot axis A-A or B-B which extends at an acute angle of a relative to longitudinal axis X.

2. A wheeled conveyance as claimed in claim 1, wherein angle α is between 75 and 89 degrees.

3. A wheeled conveyance as claimed in claim 1, wherein angle α is between 79 and 85 degrees.

4. A wheeled conveyance as claimed in claim 1, wherein angle α is between 80 and 84 degrees.

5. A wheeled conveyance as claimed in claim 1, wherein the angle α is 82 degrees.

6. A wheeled conveyance as claimed in any claim 1, wherein said angle α is such that a perpendicular L2A, L2B to axis A-A or B-B crosses said longitudinal axis X at a point C generally rearward of axis A-A or B-B.

7. A wheeled conveyance as claimed in claim 1, wherein said conveyance includes a rear axis Y-Y about which a pair of rear wheels rotate and wherein angle α is such that a perpendicular L2A, L2B to axis A-A or B-B crosses said longitudinal axis X at a point C coincident with axis Y-Y.

8. A wheeled conveyance as claimed in claim 1 and further including a rear suspension member having a left side and a right side and being mounted to said chassis for pivotal movement about the central axis X.

9. A wheeled conveyance as claimed in claim 6 and wherein said rear suspension member comprises a substantially rigid cross-member having a first end on the left side and a second end on said right side and including a longitudinal axis Y and wherein said axis Y is substantially perpendicular to the axis X of the chassis and further wherein a wheel is provided at each end and each wheel is mounted for rotation about said axis Y or about an axis substantially parallel thereto.

10. A wheeled conveyance as claimed in claim 1 and including a damping mechanism to damp any motion between the one or more front arms and the chassis.

11. A wheeled conveyance as claimed in claim 1 wherein said damping mechanism comprises a compressible member mounted on the chassis.

12. A wheeled conveyance as claimed in claim 1 and further including a compressible member above each of the front arms.

13. A wheeled conveyance as claimed in claim 1 and in which the one or more front arms are each mounted on one or more hinge plates which are each mounted on said chassis for pivotal movement about one or other of axes A-A or B-B.

14. A wheeled conveyance claimed in claim 11, wherein said one or more hinge plates includes a lower surface and wherein said damper mechanism extends between said lower surface and said first base member of the chassis.

15. A wheeled conveyance as claimed in claim 1, wherein said rear suspension member includes one or more second damping members to damp any movement of the rear suspension member about axis X.

16. A wheeled conveyance as claimed in claim 1, wherein said chassis further includes a plurality of mountings for receiving a mounted body.

17. A wheeled conveyance as claimed in claim 1, wherein said chassis includes a top plate mounted above said first member and wherein said one or more damper members are mounted therebetween.

18. A wheeled conveyance as claimed in claim 16, wherein one or more of said one or more mountings are mounted on said top plate.

19. A wheeled conveyance as claimed in claim 1 and wherein said front wheels comprise castor wheels.
